(19) United States
(12) Patent Application Publication
(10) Pub. No.: US 2013/0303282 A1
(43) Pub. Date: Nov. 14, 2013

(54) INTERACTIVE MODELING AND GUIDED DESIGN METHOD AND SYSTEM

(71) Applicant: Joseph Andrew Rietman, San Diego, CA (US)

(72) Inventor: Joseph Andrew Rietman, San Diego, CA (US)

(21) Appl. No.: 13/945,009

(22) Filed: Jul. 18, 2013

Related U.S. Application Data
(63) Continuation of application No. 13/274,325, filed on Oct. 15, 2011.

(51) Int. Cl. A63F 13/00

(52) U.S. Cl. CPC A63F 13/00
USPC 463/31

(57) ABSTRACT

Methods, systems, and apparatus, including computer programs encoded on a computer storage medium, for an interactive modeling and guided design system. In one aspect, a method includes receiving a location design from which a game is derived, defining a collection of roles based upon the game, running the game utilizing instance avatars to represent the users of the game, collecting information from the game, and altering the design of a location based upon the information.

### CROSS-REFERENCE TO RELATED APPLICATIONS

This patent application claims priority to co-pending U.S. patent application Ser. No. 13/274,325 filed on Oct. 15, 2011.

### TECHNICAL FIELD

The present invention relates to interactive modeling and guided design.

### BACKGROUND

This specification relates to modeling environments and more particularly to modeling human constructed environments.

Designing a location, for example a building, an event, or a pedestrian location is expensive and time consuming. Typically, the design effort begins with a collection of assumed design needs, design values and theorized operational aspects of the building, event, or pedestrian location. Also, various engineering and design practices, and code requirements are normally considered during the design process. For example, the design effort for a building can start with the operational aspect that the building is to hold seven law offices. Also, the building code for such a building may require that the building have a minimum number of fire escapes.

However, all of those aspects may have little in common with the actual needs and usages of the location. In short, the assumed design needs, design values and theorized operational aspects as well as design practices and code requirements may prove useless or even detrimental to the users and/or inhabitants of the location. For example, a building's landscape may render one or more of the code required fire escapes ineffective and thus prompt the need for additional fire escapes.

Various methods, such as mock-ups, drawings, blue prints, and other imaginative visualizations techniques and devices have been used to predict and provide solutions for the inadequacies of the design process. While helpful, such techniques have proven inadequate to discover and evaluate the actual needs and usages of the location that the users or inhabitants may ultimately require. Furthermore, such techniques do not readily lend themselves to iterative adaptive design processes that can be used to develop solutions for the actual needs and usages. Also, such techniques do not lend themselves to discovering new needs and usages not originally contemplated. Finally, in extreme circumstances people will utilize extreme measures. Such techniques do not lend themselves to designing structures while contemplating extreme circumstances. Thus, there is a need for an interactive modeling and guided design system. The present invention addresses these needs.

### SUMMARY

This specification describes technologies relating to an interactive modeling and guided design system.

In general, one innovative aspect of the subject matter described in this specification can be embodied in methods that include the actions of receiving a location design, deriving a game based in part upon the location design, defining a collection of roles based upon the game, wherein each role is associated with a category avatar, running the game wherein users are represented by instance avatars, collecting information from the game, and altering the location design based upon the information. Other embodiments of this aspect include corresponding systems, apparatus, and computer programs, configured to perform the actions of the methods, encoded on computer storage devices.

Particular embodiments of the subject matter described in this specification can be implemented so as to realize one or more of the following advantages. A user's participation in a game can be based upon their level of participation within pre-selected social networks and social media, yielding a game that encourages and rewards social interactions occurring outside of the game. Correspondingly, users can also design games and model environments intended to encourage and/or reward a user's actions taken outside of the game. Similarly, users can also design games that span both in game and outside of the game events. For example, a user can design a game that teaches a desired sequence of actions within the game and then rewards the participant when he performs that sequence of actions outside of the game. Users can also chain together various situations and corresponding games, permitting multi-situational games and yielding information based upon complex total sum situations unlikely to occur but important to prepare for. For example, a game could be designed to help a group of security guards prepare and practice for a possible earthquake.

Additionally, embodiments of the subject matter described in this specification can also be implemented so as to realize the ability to evaluate a person's response to a potential location. In such embodiments, the game and simulation are such that the user's response is evaluated to predict his likely response should the location be realized. For example, a stadium, the stadium's parking lots, and the connecting roadways could be simulated. In this simulation, user's behaviors could be analyzed to predict the likely traffic behavior of people going to the stadium.

In some implementations, users can be incentivized by various reward systems such as a publically viewable score boards, public ranking, prizes, and the like. In some implementations, a user's actions are guided by the user's role in a game. Roles can be used to provide a list of predetermine responses to various game situations of which the user must choose from or a number of free action responses based on the users role in the game. In some implementations, the numbers of users participating through performing the actions in line with their role provides data that can be analyzed to provide improvements for real world systems and environments. For example, a user may undertake the role of an emergency room patient and be required to express increasing levels of pain or symptoms to the other users who are participating in various roles based upon the professions found within a hospital. The other user responses to emergency room patient actions can be analyzed to yield system and structural improvements for the hospital. Similarly, the hospital staff users' reactions to various reward mechanisms can also be analyzed to provide insight and improvement for real world incentive systems.

### BRIEF DESCRIPTION OF THE DRAWINGS

FIG. 1 is a block diagram of an example environment in which an interactive modeling and guided design system can be used.

FIG. 2 is a flow chart of an example process for interactive modeling and guiding designing of a building.

FIG. 3 is a flow chart of an example process for defining the game for a modeled building.

FIG. 4 is block diagram of an example computer system that can be used to create predictive interaction models and/or compute effectiveness scores.

### Like reference numbers and designations in the various drawings indicate like elements.

### DETAILED DESCRIPTION

An interactive modeling and guided design system capable of receiving the design and/or parameters of a location and reproducing a modeled environment based upon the information. A location is a building, an event, a pedestrian location, or other similar settings where people can go. Based upon the information, the modeled environment is active in that one or more users, through the representational use of an instance avatar, are able to interact, experience and impact the modeled environment. Typically the modeled environment is visually experienced although some implementations also provide for force feedback permitting the user to also experience physical sensations as part of the modeled environment. Additionally, various scenarios or games are defined and ran or played in the modeled environment. That is, users are able to explore and experience the environments modeled in three dimensions from a first or third person viewpoint. The actions of the one or more users are structured, stored, scored, and analyzed. The analysis can be used to refine and/or alter the design and/or parameters of the location. In some implementations, the design and parameters of the location are automatically modified based upon the analysis.

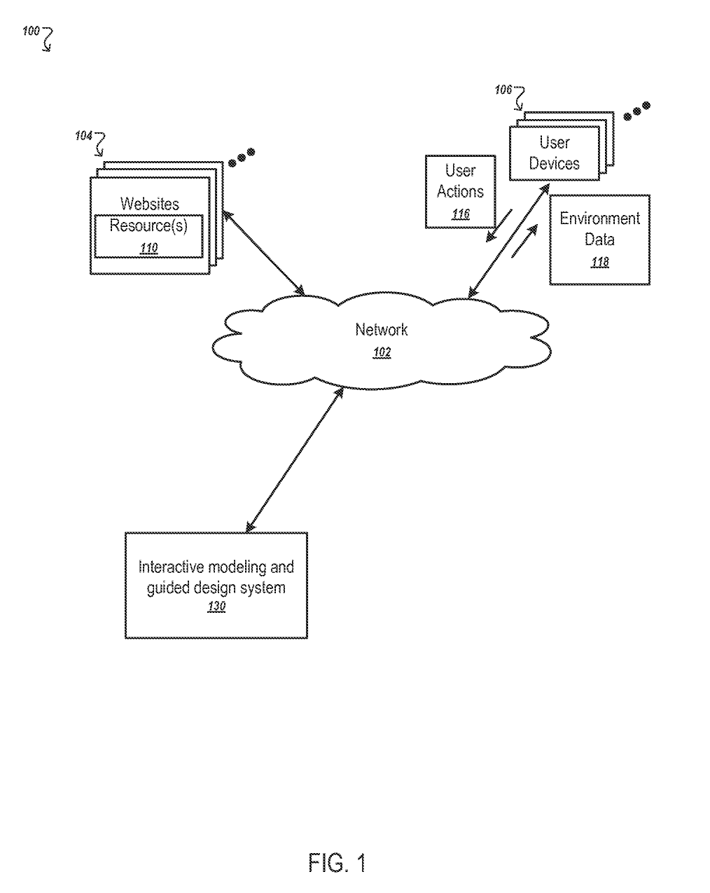

FIG. 1 is a block diagram of an example environment in which an interactive modeling and guided design system can be used. For example, the environment 100 includes an interactive modeling and guided design system 130 that provides interactive environments to users as well as providing other services such as tracking and processing information, providing environment representation translation, and the like. The example environment 100 also includes a network 102, such as a local area network (LAN), a wide area network (WAN), the Internet, a game network, a proprietary network, or a combination thereof. The network 102 connects websites 104, user devices 106, and the interactive modeling and guided design system 130. The example environment 100 may include many thousands of websites 104 and user devices 106.

A website 104 is one or more resources 110 associated with a domain name and hosted by one or more servers. An example website is a collection of web pages formatted in hypertext markup language (HTML) that can contain text, images, multimedia content, and programming elements, such as scripts. Each website 104 is maintained by a publisher, which is an entity that controls, manages and/or owns the website 104.

A resource 110 is any data that can be provided over the network 102. A resource 110 is identified by a resource address (URL) that is associated with the resource 110. Resources include HTML pages, word processing documents, and portable document format (PDF) documents, images, video, and feed sources, to name only a few. The resources can include content, such as location data and information. For example, the resources can include building schematics, words, phrases, images and sounds, that may include embedded information (such as meta-information in hyperlinks) and/or embedded instructions (such as JavaScript scripts) that serve to detail the location. Units of content (e.g., building schematics, data files, scripts, content files, or other digital data) that are presented in (or with) resources are referred to as content items. In some implementations, the interactive modeling and guided design system 130 also contains location data, information, schematics, and the like.

A user device 106 is an electronic device that is under control of a user and is capable of sending the user actions 116 to, and receiving environment data 118 from the interactive modeling and guided design system 130. Typically, a user action 116 is a user instruction causing the user's instance avatar to perform some act in a game. An instance avatar is the instantiation of a category avatar and serves to represent a user.

Environment data 118 is the game information that the user device 106 requires in order to portray the game to the user. In some implementations, the user device 106 is also capable of requesting and receiving resources over the network 102. Example user devices 106 include personal computers, mobile communication devices, game systems, and other devices that can send user actions 116 and receive environment data 118 over the network 102. Typically, a user device 106 includes a user application to facilitate the user actions 116 and receive environment data 118 over the network 102. For example, a user's pc could be equipped with a flash application capable of sending user actions 116 and producing a visual representation for the user based upon the received environment data 118.

The interactive modeling and guided design system 130 provides an environment where users can formulate dimensional representations of locations such as buildings, public events, pedestrian locations, and the like. Providing interactive design guidance modeling, also known as “I-DGM”, the interactive modeling and guided design system 130 enables users to provide various games or scenarios for use with the dimensional representations. Users can also incorporate various elements into their games such as doors, valves, electrical switches, windows, cars, non-player-characters, and the like. The elements typically maintain and are incorporated with a high degree of realism in that the elements have realistic dimensions, realistic locations, and require realistic manipulations when interacted with. For example, a user could formulate the representation of an office park and specify a game where a gas line explosion had occurred and several individuals are injured and/or trapped in one of the buildings of the office park.

As such and part of I-DGM, the interactive modeling and guided design system 130 also enables the evaluation and improvement of a location's aspects different from the dimensional aspects of the location. Users can provide various games or scenarios for a location focusing on aspects such as the location's safety, functionality, business performance evaluation, efficiency of space usage, comfort, and the like. For example, a game could be designed where users had to move freight within a simulated factory to evaluate the factory's design for the purpose of efficiency.

In the office park game example, other users could play the roles of first responders, injured participants and on-lookers and the interactive modeling and guided design system 130 would track their actions and movements within the game. In this example, the interactive modeling and guided design system 130 would provide a realistic and interactive environment such as the injured and/or trapped individuals, shattered concrete, extremes of heat (typically realized as harm to a user's instance avatar), shattered windows, jammed doors, and the like as part of the game. The interactive modeling and guided design system 130 would record the actions of the users as user data. For example, the interactive modeling and guided design system 130 would record the paths taken by the users, the difficulties in those paths, the actions required to give assistance to the injured and/or trapped individuals, and the like. In some implementations, the interactive modeling and guided design system 130 also performs analysis of the user data. In some implementations, the interactive modeling and guided design system analyses the data to look for points of contention or collisions and will offer design changes intended to alleviate such building flaws. Additionally, some implementations permit users within the game to virtually tag areas of concern during the simulation, permitting the diverse viewpoints and experiences of the users to assist in further refinement of the building design. Furthermore, some implementations anonymized the users in order to protect the privacy of the users that play in the games and to further encourage frank and honest user interactions.

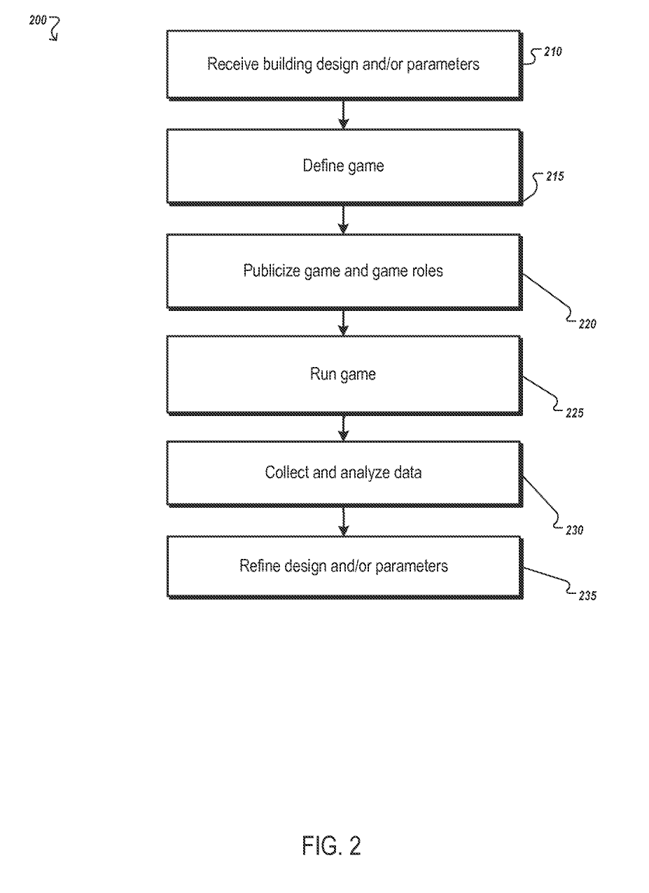

FIG. 2 is a flow chart of an example process 200 for interactive modeling and guiding designing of a building. The process 200 is a process by which the information about a location such as a building, event, or pedestrian location, or the like is gathered, modeled, and a game or games are defined the building, event, or pedestrian location. The process 200 is described below with reference to refining the design of a building. However, the process 200 can also be used to determine the flaws in other locations such as an existing building, event, pedestrian location, or the like. Alternatively, the process can also be used to detect the issues with elements or parts of a location such as the elements or parts of a building, event, pedestrian location, or the like, or to plan and/or practice an action upon an existing or theoretical location.

The process 200 can be implemented, for example, by the interactive modeling and guided design system 130 of FIG. 1. In some implementations, the interactive modeling and guided design system 130 are data processing apparatus that include one or more processors configured to perform actions of the process 200. In some implementations, a computer readable medium can include instructions that, when executed by a computer, cause the computer to perform actions of the process 200.

Data concerning the design and parameters of a building is received (210). In some implementations, data concerning the design and parameters of a building is obtained from design documents such a blue prints or electronic design information such as that from a computer aided design system. In some implementations, the design and parameters of a building can be obtained using three dimensional laser scanning, a technique that can be used to collect data on a building's shape, dimension and color. In some implementations, the design and parameters of a building can be obtained from geospatial input or image analysis techniques. Geospatial input is a technique that provides spatial information about a building by providing Geographic Information System (GIS) information about various locations of a building. Similarly, image analysis techniques can provide design information about a building though the analysis of one or more images of the building. For example, the blue prints of a building can be scanned into a digital format. The resulting digital information can be adjusted and scaled using digital information tools such as those found in computer aided design systems. The resulting information can then be used to construct a model of the building in and about which a game or simulation will be ran.

In some implementations, receiving the design and parameters of a building (210) includes receiving information and/or the user making default decisions about elements. Elements are defined as the items that are conceived as having a separate existence from the building. Elements typically are able to have an action performed upon them. Examples of elements include furniture such as desks, chairs, potted plants, bookcases, tables, and the like, and building components such as doors, windows, elevators, and the like. Elements have attributes that denote various qualities of the modeled element such as whether the modeled element can be moved, it's weight or mass, and if it is actionable along with the results of an action. A light switch is an example of an actionable element with an action result of turning on/off a light. As another example, elements could be representative of grocery store products for a simulation to determine product placement within a grocery.

In some implementations, the attributes of an element can be set to various default values. The default values can be grouped into commonly used groupings of default values. Each default grouping represents a collection of attributes commonly found together when modeling elements. Some example default groupings include openable, breakable, movable, and the like. For example, a door would have the default grouping of openable indicating that the door can be opened and swings partially about an axis when opening.

In some implementations, elements are automatically added to the simulation's representation. The elements can be identified and added through various machine intelligence techniques and/or automatic simulation defaults. For example, doors can be automatically added to the entryway of a room as a default while sprinkler systems can be added to office buildings as a matter of rule based machine reasoning. Additionally, in some implementations, users can add elements during the development of the simulation. For example, a user can specify that a desk be placed in the middle of a conference room that is part of a simulation being developed.

In some implementations, the information concerning previously modeled buildings is retained by the interactive modeling and guided design system 130. The retained information enables multiple and possibly different games to be ran for the same modeled building. Additionally, the retained information can be used to assist in the development of other simulations. For example, previously defined elements can be used in the simulations of other buildings.

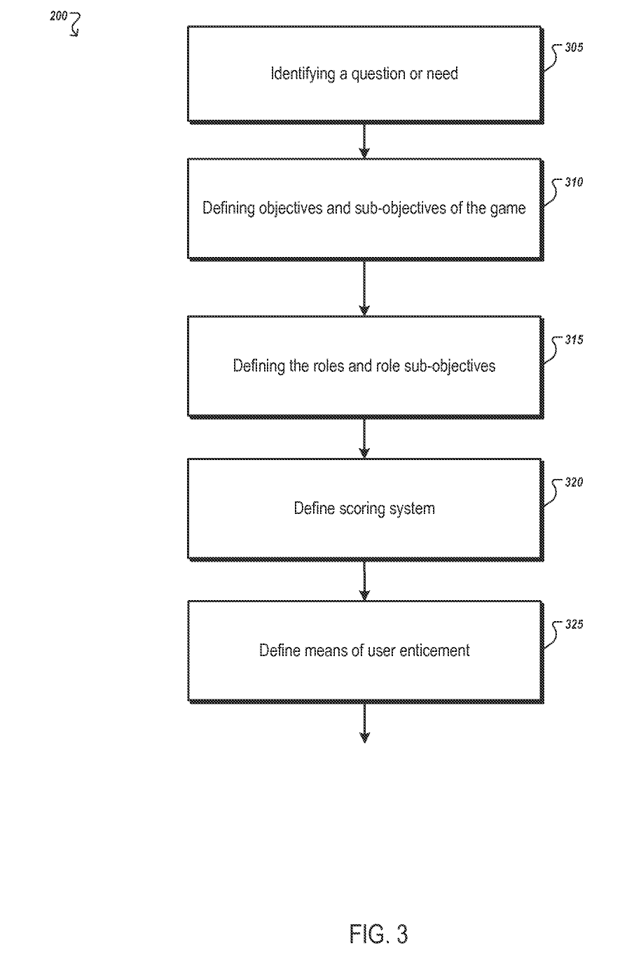

After data concerning the design and parameters of a building is received (210), the user defines the game (215). A game is an implicit statement of the desired simulation, often focused upon answering some question about the building's design. A game may have different roles that the users may fulfill during the game. For example, a game can be defined that sets up a simulation of the evacuation of a building. This simulation permits users to practice evacuating the building while collecting data to analyze and answer questions concerning the building's design with respect to evacuation. Defining the game (215) is covered in more detail in FIG. 3. Publicizing the game and the game's roles (220) is the act opening the game up for other users to participate in. In some implementations, publicizing the game can include distributing game access and participation information. That is, informing other potential users about the game, game login identifications and passwords, game times, and the games roles. In some implementations, publicizing the game is done on a game network such as that maintained by the Sony ® corporation or the Microsoft ® corporation.

At the game time, the game is run (225). In some implementations, running the game involves utilizing a client-server system architecture where the interactive modeling and guided design system 130 serves as the server. The interactive modeling and guided design system 130 generates a game-persistent instance of the building, and players connect to it via the user devices 106. Typically, each user controls and is represented as an instance avatar within the game-persistent modeled instance of the building. In some implementations, the interactive modeling and guided design system 130 utilizes one or more computers running a game engine to generate the game-persistent instance of the building. A game engine is a collection of functionalities expressed in software and/or hardware. A game engine typically provides a means for rendering two or three dimensional images and graphics, a physics system including collision detection and collision response, sound, scripting, animation, artificial intelligence, networking, streaming, memory management, threading, localization support, and the like. Typically, the game engine also provides for realistic interaction proximity limitations such as proximity limitations upon sight, speech, sound, physical interaction, and the like. The C4 Engine available from Terathon, LLC. is an example of a game engine with such proximity limitations.

During the game, data concerning the actions, scores, and the like are collected (230). and stored by the interactive modeling and guided design system 130. The collected data is used in the refining of the design and/or parameters of the building (235). The collected data can be used to analyze the building's design for purposes of detecting design flaws with respect to the simulation. For example, the collected data can be used to show whether or not key avenues of exit from the building were overly congested during the game where the office workers and security guards had to make an emergency escape.

Additionally, some implementations work to capitalize upon the experience, reasoning, insight, and the like of the users when altering the design. Permitting interactive human experience modeling (“I-HEM”), these implementations enable users to suggest building design alterations or even provide building design alterations. Benefiting not only from the analysis of the actions of the users, the I-HEM implementations also benefit from direct input from the users. In some implementations, the users are constrained in their suggested or provided alterations in that they are only able to modify the parameters of the design. Alternatively, in some implementations the users are able to completely modify the design. For example, the users in one game may be able to lengthen or shorten a hallway while in other games the users may be able to entirely do away with the hallway.

In some implementations, the interactive modeling and guided design system 130 will make refinements to the building's design and/or parameters and express these refinements in subsequent games. This in turn permits iterative development techniques to be utilized in the refinement of a building's design though the running of many games with each successive game's building benefiting from the refinements from the previous games.

Additionally, some implementations directly interact with three dimensional physical modeling and/or manufacturing systems. Typically the interaction with three dimensional physical modeling and/or manufacturing systems occurs after the building design has stabilized. The interaction with the manufacturing systems enables the manufacturing of the refined design to employ automated construction techniques. For example, the interactive modeling and guided design system 130 can directly interact with an automated manufacturing facility, to produce components or portions of the refined design. Alternatively, the interactive modeling and guided design system 130 can interact with a three dimensional modeling system to produce a physical model of the design. The physical model provides for the touch and feel of the refined building design. For example, the interactive modeling and guided design system 130 can directly interact with a three dimensional printer or similar systems that produce physical mock ups of building designs.

FIG. 3 is a flow chart of an example process 300 for defining the game for a modeled building. The process 300 is a process by which the information and goals of a game are determined for a simulation. However, the process 300 can also be used to define game applicable to a collection of simulations, and the simulations can even be of different buildings, events, pedestrian locations, or the like.

The process begins with identifying a question or need (305). That is, some aspect, attribute, dimension, potential situation, or use of the building needs to be evaluated. For example, the user could have a question about a building's design for ease of exit from the building during a fire.

Identifying the question or need (305) enables the next step of defining the objectives and sub-objectives of the game (310). The objectives and sub-objectives are the actions or events that the users playing the game should accomplish during the game. Additionally, objectives and sub-objectives are normally related to the question or need that the game is trying to evaluate. Continuing with the fire escape example, the objective would be to exit the building under some pre-defined time limit. An example of a sub-objective for the fire escape example would be keeping one's instance avatar within certain proximity of the instance avatar of other users during exiting of the building.

Defining the roles and role sub-objectives (315) involves defining the possible roles that the users can fulfill during a game. In some games, the users can choose among two or more different roles, game functions, to play in during the game. Each role can have sub-objectives. For example, the fire escape example could have the roles office worker and security guard. The role of the office worker would have the objective to escape from the building under a given time limit. The role of the security guard would have a sub-objective to ensure that all the office workers escaped from the building before the time limit has expired.

Each role is associated with a category avatar. Similar to the difference between a class and an instance of a class in object oriented design, an instance avatar is the instantiation of a category avatar and serves to represent a user. A category avatar is the definition of a type of avatar. For example, a category avatar could be a security guard avatar, it would be associated to the role of the security guard of the previous example, and a user fulfilling the role of a security guard in a game would be represented by an instance avatar of the security guard category avatar.

Category avatars for different roles may have unique actions. For example, the security guard category avatar would have an action of being able to direct other users (instance avatars) while the office worker category avatar would not.

Note that the simulation environment provides for possible real world interactions typically not able to be considered when using typical design methods. Typically, the exit rate of a building is normally estimated by mathematical algorithms. However, it is commonly understood that people will undertake extreme actions within extreme situations. People will trample, shove, harm and even kill other people in extreme circumstances. The simulated environment and game setting enables the studying of a building design under extreme circumstances. For example, the game utilizing the roles of a security guard and office employees could be adjusted to only allow a few to escape successfully in order to predict the most likely building areas of hostility provoking congestion during an emergency exit. The game could then be re-run after modifying the design to reduce the points of congestion in order to predict if the design reduces the likelihood of hostility during an emergency exit.

Similarly, the simulation can also be used to help train users for real world experiences that are contemplated but are too costly or dangerous to practice with in real life. Typically, job training, soldier training, and the like are performed using a series of physical training scenarios where individuals learn various skills in a controlled environment. But using a controlled environment precludes actual experience with the real dangers. Use of the interactive modeling and guided design system 130 enables users to gain first-hand experience with the simulated dangers. For example, a user training for a job using a fork lift in a chemical warehouse could see the impact of a careless turn rather than just being instructed about the consequences of his carelessness.

Alternatively, the interactive modeling and guided design system 130 can be used to help the users to prepare for stressful events by familiarizing the users with the environment of the stressful event. For example, users can be familiarized with the environment of a new work location for a first day on the job stressful event, familiarized with a hospital for an upcoming medical procedure such as child birth or the like. Continuing with the familiarization with a hospital example, the expectant father's role would include familiarizing events such as guiding his wife through the hospital, checking in, going to the cafeteria, walking the hospital layout, and the like. Similarly, the wife's role would involve familiarizing events from an expectant mother's viewpoint.

Additionally, the simulation can be used to determine the desirability of a location and/or predict the response of the public to a location. It can be very costly and difficult to predict the value of a proposed or existing location to the general public and how the public will behave to such a location. For example, a retail space developer or business could design a game utilizing a simulation of a potential developed site to evaluate potential customer traffic, customer behavior, evaluate customer service strategies, marketing and marketing strategies, space management, and to promote future customer loyalty. For such a game, the possible roles can include customer, store employee, and the like. An example of a means of user enticement for this scenario could be to reward the players with a discount based upon the player's score.

A user is scored upon his actions during the simulation. Defining the scoring system (320) involves defining which actions and the time that actions receive points. In some implementations, the scoring system can utilize events or information external to the game when scoring a user's performance in a game. For example, the fire escape game could have a score system based upon how long it takes the user to exit the building. Additionally, repeat participation by a user could be rewarded by an increased score as a means to value the external to the game familiarity with the building.

Defining a means of user enticement (325) involves defining a means to encourage user participation in the games. The means of enticement can vary in complexity and can be as simple as a public ranking of the performances of the users. Enticing users to participate in the game helps to ensure that a game will have sufficient participants such that the collected data can be used to make meaningful adjustments to the building design. Some implementations require a certain level of user participation in simpler simulations before being permitted to participate in more elaborate simulations or roles. For example, a user could be required to play the role of an office worker several times before being permitted to play the role of a security officer.

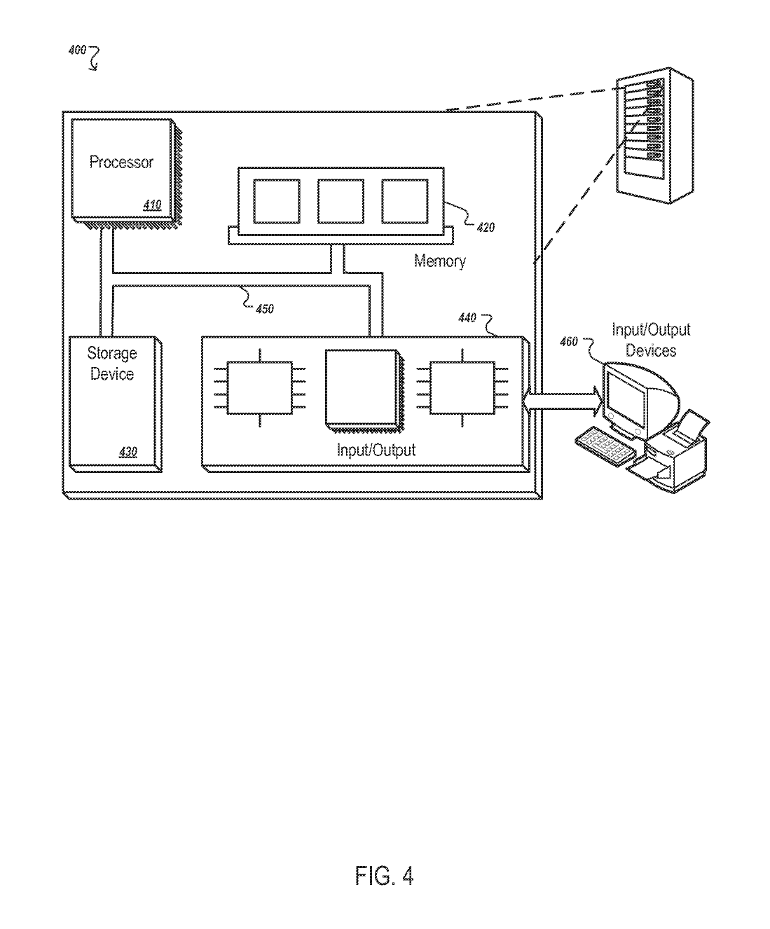

FIG. 4 is block diagram of an example computer system 400 that can be used to implement the interactive modeling and guided design system 130. The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 can include, for example, a hard disk device, an optical disk device, or some other large capacity storage device.

The input/output device 440 provides input/output operations for the system 400. In one implementation, the input/output device 440 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 460. Other implementations, however, can also be used, such as mobile computing devices, mobile communication devices, set-top box television client devices, etc.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them.

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

While the novel technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the novel technology are desired to be protected.

1. A virtual environment simulation method comprising:
receiving, by a computer, a location design including specifications of a spatial environment, specifications for virtual objects within that environment, and specifications for a placement of those virtual objects within that environment;
defining, by the computer, a subset of virtual objects as emergency objects;
defining a collection of roles based upon the game wherein each role is associated with a category avatar and each category avatar may interact with a subset of virtual objects;
attributing, by the computer, a subset of category avatars with emergency object interaction capabilities;
deriving a game based in part upon the location design, placement of virtual objects, and placement of emergency objects;
running, by the computer, the game wherein users are represented as instance avatars and each instance avatar is at least one type of category avatar;
collecting, by the computer, information from the game;
determining, by the computer, optimal response times and resource allocation based upon the collected information; and
altering, by the computer, the placement location of emergency objects within location based upon the collected information determinations.

2. A method of claim 1, wherein the instance avatar of each user is within a game-persistent modeled instance of the location design.

3. A method of claim 2, wherein the game-persistent modeled instance is generated through use of a game engine.

4. A method of claim 2, wherein the game-persistent modeled instance is generated on a server and users connect to the server as clients.

5. A method of claim 1, further comprising:
receiving, by a computer, a list of employees; and
attributing, by a computer, to said list of employees emergency object interaction capabilities.

6. A method of claim 1, wherein collecting information from the game further comprises receiving user-submitted alterations of placement of emergency objects.

7. A method of claim 1, further comprising:
defining a scoring system wherein the scoring system is used to score user actions during the game;
publicizing the game; and
defining a means of user enticement, wherein the user enticement encourages the users to participate in the game.

8. A method of claim 7, wherein publicizing the game involves distributing game access information through a game network.

9. A method of claim 1, wherein receiving the location design involves receiving elements, each element having a separate existence from a simulated location based upon the location design.

10. A method of claim 9, wherein the elements are automatically added to the simulated location.

11. A method of claim 1, wherein receiving the location design is receiving a building design.

12. A system for simulating a virtual environment comprising:
at least one user device;
one or more computers operable to interact with the at least one user device; and
a network connecting the at least one user device and the one or more computers;
wherein the one or more computers are configured to perform the operations of:
receiving a location design including specifications of a spatial environment, specifications for virtual objects within that environment, and specifications for the placement of those virtual objects within that environment;
defining a subset of virtual objects as emergency objects;
defining a collection of roles based upon the game wherein each role is associated with a category avatar and each category avatar may interact with a subset of virtual objects;
attributing a subset of category avatars with emergency object interaction capabilities;
deriving a game based in part upon the location design, placement of virtual objects, and placement of emergency objects;
running the game wherein users are represented as instance avatars and each instance avatar is at least one type of category avatar;
collecting information from the game, the information based upon actions of the users, wherein each user acts according to his or her assigned role;
analyzing collected information from the game to determine usage of emergency objects during game; and
altering the placement location of emergency objects within location based upon the analyzed information.

13. The system of claim 12, wherein the one or more computers are further configured to perform the operation of receiving user supplied alterations of the location design.

14. The system of claim 12, wherein the one or more computers are further configured to perform the operation of populating the simulation with elements, each element having an existence separate from a location represented within the simulation.

15. The system of claim 12, wherein the one or more computers are further configured to perform the operation of interacting with one or more game networks and the users of the game networks are enabled to participate in the game.

16. The system of claim 12, wherein the one or more computers are further configured to perform the operation of interacting with a three dimensional modeling system, the three dimensional modeling system capable of rendering a physical model of the altered location design.

17. The system of claim 12, wherein the one or more computers are further configured to perform the operation of providing for proximity limitations between the users of the game.

18. The system of claim 12, wherein the one or more computers consist of one computer, the device is a user interface device, and the one computer comprises the user interface device.

19. A computer-readable medium having instructions stored thereon, which when executed by one or more computers, causes the one or more computers to:
receive a location design including specifications of a spatial environment, specifications for virtual objects within that environment, and specifications for a placement of those virtual objects within that environment;
define a subset of virtual objects as emergency objects;
define a collection of roles based upon the game wherein each role is associated with a category avatar and each category avatar may interact with a subset of virtual objects;
attribute a subset of category avatars with emergency object interaction capabilities;
derive a game based in part upon the location design, placement of virtual objects, and placement of emergency objects;
run the game wherein users are represented as instance avatars and each instance avatar is at least one type of category avatar;
collect information from the game;
determine optimal response times and resource allocation based upon the collected information; and
alter the placement location of emergency objects within location based upon the collected information determinations.
